(19) United States
(12) Patent Application Publication
(10) Pub. No.: US 2007/0114245 A1
(43) Pub. Date: May 24, 2007

(54) Fuel container

(76) Inventor: James R. Trent JR., Stow, OH (US)

Correspondence Address: BROUSE MCDOWELL LPA, 388 SOUTH MAIN STREET, SUITE 500, AKRON, OH, 44311, US

(21) Appl. No.: 11/545,953

(22) Filed: Oct. 11, 2006

Related U.S. Application Data
(60) Provisional application No. 60/725,434, filed on Oct. 11, 2005.

(51) Int. Cl. B67D 5/38; A47J 45/06

(52) U.S. Cl. 222/158; 222/466

(57) ABSTRACT

An aspect of the present invention includes an apparatus for mixing and dispensing liquid fuel with another fluid, including a container having a base, a plurality of side walls, a cover portion, and an opening formed in the cover portion for receiving and dispensing liquids. At least one of the sidewalls has a translucency allowing a liquid level to be determined. First and second handles aid in the control of dispensing of liquids from the container. A plurality of fill lines are formed at predetermined locations on or near the sidewall(s) having a translucency to compare the liquid level to the fill lines. The fill lines are incrementally spaced such that the volume associated with the lowermost fill line is substantially equal to the volume associated with to any of the other fill lines spaced above the lowermost fill line minus the volume associated fill lines positioned therebelow.

### BACKGROUND OF THE INVENTION

1. Field of the Invention

This invention relates in general to the art of methods and apparatuses for a fuel, and in particular to a container that provides for easy and precise mixing of a liquid fuel with another fluid.

2. Background of the Invention

It has been known for some time that obtaining the proper mixture of fuels or additives has been an inexact, and frequently messy, science. Typically, the fuel and additives are measured is separate containers, and calculations are made in order to determine the proper amount of each. Additives

### SUMMARY OF THE INVENTION

The purpose of the invention is to provide a fuel jug or fuel container that has a percentage of fill feature, that will allow easy measurement of fuel/additive percentages.

In accordance with one aspect of the present invention, a fuel jug allows the user to mix fuels or additives within the jug.

Still other benefits and advantages of the invention will become apparent to those skilled in the art to which it pertains upon a reading and understanding of the following detailed specification.

An aspect of the present invention includes an apparatus for mixing and dispensing liquid fuel with another fluid. The apparatus includes a container having a base, a plurality of side walls, a cover portion, and an opening formed in the cover portion for receiving and dispensing liquids. At least one of the sidewalls has a translucency that allows a level of a liquid inside of the container to be determined when viewed from an exterior of the container. A first handle extends substantially parallel to at least one of the sidewalls. A second handle extends substantially along the cover portion such that the second handle extends at an angle to the first handle. The combination of the first and second handles aid in the control of dispensing of liquids from the container. A plurality of incrementally spaced fill lines are formed at predetermined locations on or near the at least one of the sidewalls having a translucency so that the level of the liquid inside the container can be compared to the fill lines. The plurality of fill lines are incrementally spaced such that the volume of liquid associated with the lowermost fill line is substantially equal to the volume of liquid associated with to any of the other fill lines spaced above the lowermost fill line minus the volume of liquid associated fill lines positioned therebelow, thereby allowing for precise mixtures of the liquid fuel with the another fluid.

The another fluid comprises a fuel additive, such as for increasing the octane level of the fuel or for producing a cleaner burning fuel, or a motor oil. The cover portion can include an angled portion that extends at angles relative to the sidewalls in a conical manner, a side portion that extends substantially parallel with one of the sidewalls and a flat portion that is substantially parallel with the base, thereby causing the cover portion to have a substantially frusto-conical shape. The opening can be formed in the flat portion of the cover portion of the container.

The second handle can be formed along an intersection of surfaces extending from the sidewalls and forming the angled portion of the cover portion. The first handle can be formed along an intersection of sidewalls positioned opposite from the sidewall from which the side portion of the cover portion extends.

Another aspect of the present invention includes a method of mixing and dispensing liquid fuel with another fluid. The method includes the step of (a) providing a container having a base, a plurality of side walls, a cover portion, and an opening formed in the cover portion for receiving and dispensing liquids, at least one of the sidewalls having a translucency that allows a level of a liquid inside of the container to be determined when viewed from an exterior of the container. The method also includes the step of (b) providing a plurality of incrementally spaced fill lines formed at predetermined locations on or near the at least one of the sidewalls having a translucency so that the level of the liquid inside the container can be compared to the fill lines, the plurality of fill lines being incrementally spaced such that the volume of liquid associated with the lowermost fill line is substantially equal to the volume of liquid associated with to any of the other fill lines spaced above the lowermost fill line minus the volume of liquid associated fill lines positioned therebelow. The method further includes the step of (c) pouring the liquid fuel into the container through the opening until the liquid level of the liquid fuel is substantially even with a first predetermined one of the plurality of fill lines. The method also includes the step of (d) pouring the another fluid into the container through the opening until the liquid level of the liquid fuel and the another fluid is substantially even with a second pretermined one of the plurality of fill lines to achieve a pre-selected mixture of liquid fuel and the another fluid. And the method include the step of (e) dispensing the pre-selected mixture of liquid fuel and the another fluid through the opening.

The method can include that in step (e) a first handle extending substantially parallel to at least one of the sidewalls, and a second handle extending substantially along the cover portion such that the second handle extends at an angle to the first handle are used to control the dispensing of liquids from the container.

The method can also include the step of (f) closing the opening with a cover cap and storing the pre-selected mixture and the another fluid within the container for dispensing at a later time.

Prior to step (e) the method can include the step of causing turbulence within the container to disperse the another fluid substantially throughout the liquid fuel. The causing turbulence can be performed by shaking the container or by stirring the liquid fuel and the another fuel mixture with a tool that is inserted through the opening.

### BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is a perspective view of a fuel container in accordance with an embodiment of this invention.

### DETAILED DESCRIPTION OF THE PREFERRED EMBODIMENT

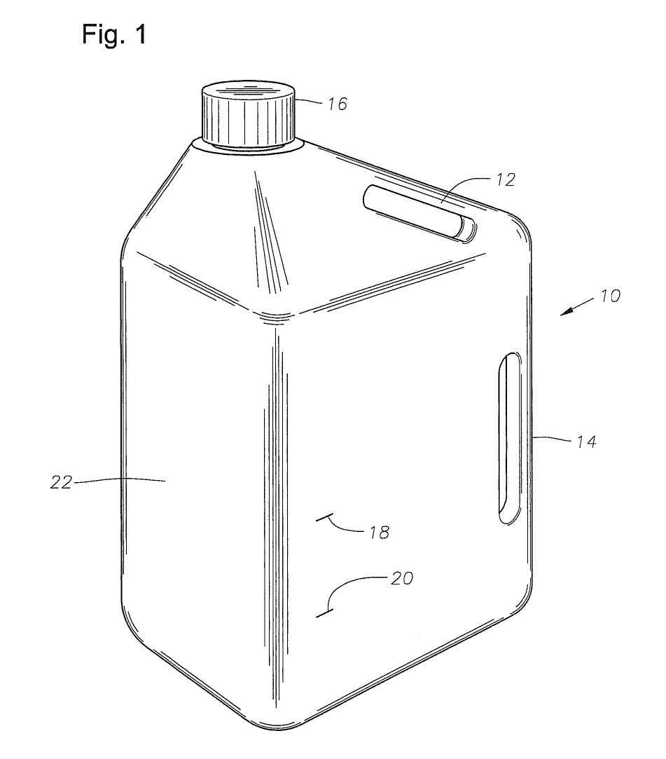

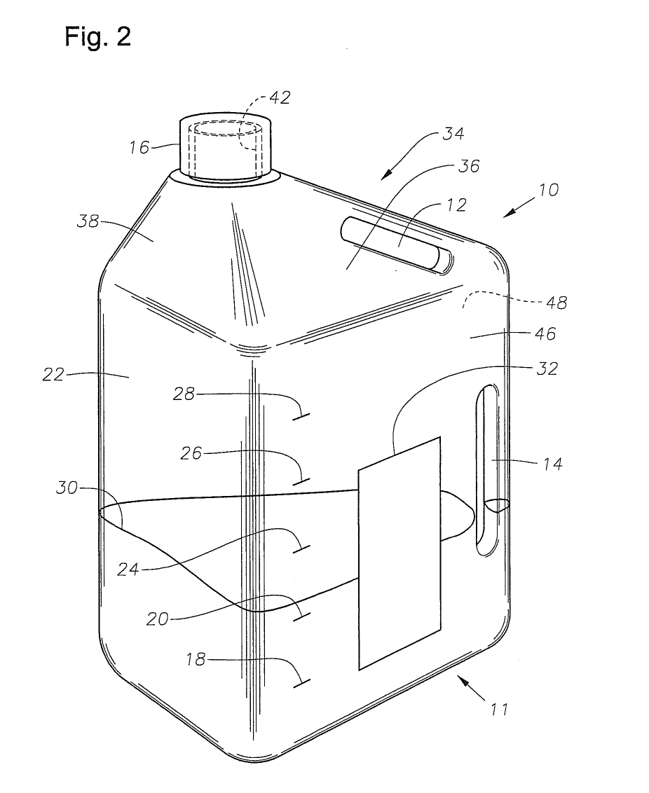

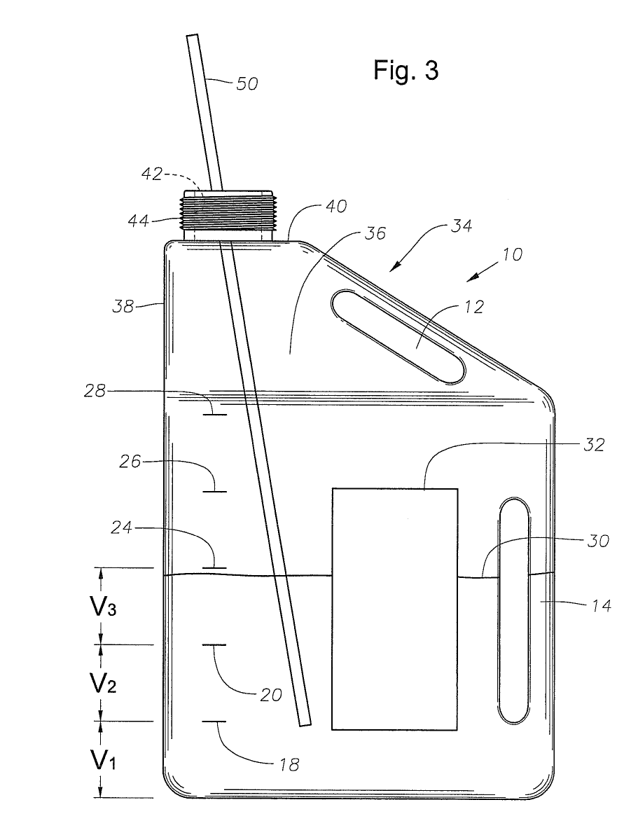

Referring now to the drawings wherein the showings are for purposes of illustrating at least one embodiment of the invention only and not for purposes of limiting the same, FIGS. 1-3 show the fuel jug or container 10 having a base 11, a first handle 14, a second handle 12, a cap 16, first and second fill lines 18, 20, and a fuel jug side 22. In the preferred embodiment, side 22 is one of a plurality of sidewalls, which include sidewalls 46 and 48. In the preferred embodiment, sidewalls 22,46,48 extend from base 11 and a cover portion 34 helps to enclose the ends of sidewalls 22,46,48 opposite from base 11. Cover portion 34 preferably includes an opening 42 for receiving and dispensing the liquid fuel and the additional fluid additives or fuels. Cap 16 engages threads 44 formed around opening 42 for sealingly closing opening 42. In the preferred embodiment, cover portion includes a side portion 38 extending substantially parallel with side 22 and angled portions 36 extending at angles relative to sidewalls 46,48 and approaching side portion 38. As perhaps best shown in FIG. 3, angled portions 36 and side portion 38 are connected via a flat portion 40, which gives the cover portion a substantially frusto-conical shape. Opening 42 is preferably formed along a position that is offset from an axis or centerline of container 10. Such positioning can help with controlling the dispensing of a mixture of fluids from within container 10.

In the preferred embodiment, second handle 12 is formed along a junction or intersection of angled portions 36, and second handle 12 extends substantially parallel with such intersection. Similarly, first handle 14 is formed along a junction or intersection of sidewalls 46,48 and extends substantially parallel with such intersection, thereby causing second handle 12 to extend at an angle relative to first handle 14.

The fill lines 18,20 of FIG. 1 are exemplary for showing an example of the invention having at least a plurality of fill lines, and is not intended to limit the invention. As shown in FIGS. 2 and 3, there can be numerous fill lines 18,20,24,26,28, which can each show the amount of fuel and/or additive to add in order to obtain the proper mixture. The positioning of the fill lines 18,20,24,26,28 preferably correspond to substantially incrementally equal volumetric parts of container 10. As shown in FIG. 3 for example, the volume associated with fill line 18 is V₁, the volume associated with fill 20 is V₂, and the volume associated with fill line 24 is V₃. In the preferred embodiment, V₁ is substantially equal to V₂−V₁ and is also substantially equal to V₃−(V₂+V₁). By providing that each line has substantially equal volumetric parts of container 10 associated therefore, easier mixing can occur. As best shown in FIGS. 2-3, container preferably has at least one of sidewalls 22,46,48 with a translucency that allows a level of a liquid, or a liquid level 30 found inside of the container 10 to be determined when viewed from an exterior of container 10.

The fill lines 18, 20 can be placed on the container 10 in order to obtain any mixture that is desired (e.g., 2:1, 3:1, 4:1). It can also be used to obtain certain percentages of fuel to additive, such as a 25% fuel mixture. However, it is to be understood that any mixture ratio or percentage can be obtained using this invention. Container 10 preferably includes printed instructions 32 that are attached to an outer surface of at least one of sidewalls 22,46,48 so that the user can predetermine which fill line 18,20,24,26,28 to pour fluid into the container to when adding the liquid fuel or another liquid. For example, for a 3:1 ratio, the instructions would advise the user to fill the liquid fuel to fill line 24, and the another fluid or additive to fill line 26. It is to be understood that any number of fill lines could be used in order to obtain the desired ratio or percentage. A tool 50 can be used to stir or cause turbulence of the mixture of fluid within container 10 to help disperse the another fluid or additive being mixed with the liquid fuel throughout the liquid fuel. Such turbulence can also be caused by shaking container 10.

In this embodiment, the container 10 is a rotationally molded, high density cross-linked polyethylene jerrican. The container 10 has a rated capacity of six gallons when filled in the filling and storage position. The container 10 is designed to be used for portable dispensing and storage of gasoline. One handle 12 is the top of the container 10 and the other handle 14 is at the bottom. The container 10 has a threaded cap 16 with a gasket to prevent spills in the storage and transporting position. It is to be understood that the above description is merely one embodiment of the present invention.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

While the invention has been shown in only some of its forms, it should be apparent to those skilled in the art that it is not so limited, but susceptible to various changes without departing from the scope of the invention. For example, more sidewalls could be added to form a four-sided container, or the opening could be positioned substantially in-line with the axis or centerline of the container rather being offset as shown in FIGS. 1-3.

That claimed is:

1. An apparatus for mixing and dispensing liquid fuel with another fluid, comprising:
a container having a base, a plurality of side walls, a cover portion, and an opening formed in the cover portion for receiving and dispensing liquids, at least one of the sidewalls having a translucency that allows a level of a liquid inside of the container to be determined when viewed from an exterior of the container;
a first handle extending substantially parallel to at least one of the sidewalls;
a second handle extending substantially along the cover portion such that the second handle extends at an angle to the first handle, the combination of the first and second handles aiding in the control of dispensing of liquids from the container;
a plurality of incrementally spaced fill lines formed at predetermined locations on or near the at least one of the sidewalls having a translucency so that the level of the liquid inside the container can be compared to the fill lines, the plurality of fill lines being incrementally spaced such that the volume of liquid associated with the lowermost fill line is substantially equal to the volume of liquid associated with to any of the other fill lines spaced above the lowermost fill line minus the volume of liquid associated fill lines positioned therebelow, thereby allowing for precise mixtures of the liquid fuel with the another fluid.

2. The apparatus of claim 1, wherein the another fluid comprises a fuel additive.

3. The assembly of claim 1, wherein the another fluid comprises a motor oil.

4. The apparatus of claim 1, wherein the cover portion includes an angled portion that extend at angles relative to the sidewalls in a conical manner, and a side portion that extends substantially parallel with one of the sidewalls, and a flat portion that is substantially parallel with the base, thereby causing the cover portion to have a substantially frusto-conical shape.

5. The apparatus of claim 4, wherein the opening is formed in the flat portion.

6. The apparatus of claim 4, wherein the second handle is formed along an intersection of surfaces extending from the sidewalls and forming the angled portion of the cover portion.

7. The apparatus of claim 4, wherein the first handle is formed along an intersection of sidewalls positioned opposite from the sidewall from which the side portion of the cover portion extends.

8. A method of mixing and dispensing liquid fuel with another fluid, comprising:
(a) providing a container having a base, a plurality of side walls, a cover portion, and an opening formed in the cover portion for receiving and dispensing liquids, at least one of the sidewalls having a translucency that allows a level of a liquid inside of the container to be determined when viewed from an exterior of the container;
(b) a plurality of incrementally spaced fill lines formed at predetermined locations on or near the at least one of the sidewalls having a translucency so that the level of the liquid inside the container can be compared to the fill lines, the plurality of fill lines being incrementally spaced such that the volume of liquid associated with the lowermost fill line is substantially equal to the volume of liquid associated with to any of the other fill lines spaced above the lowermost fill line minus the volume of liquid associated fill lines positioned therebelow;
(c) pouring the liquid fuel into the container through the opening until the liquid level of the liquid fuel is substantially even with a first predetermined one of the plurality of fill lines;
(d) pouring the another fluid into the container through the opening until the liquid level of the liquid fuel and the another fluid is substantially even with a second pretermined one of the plurality of fill lines to achieve a pre-selected mixture of liquid fuel and the another fluid; and
(e) dispensing the pre-selected mixture of liquid fuel and the another fluid through the opening.

9. The method of claim 8, wherein in step (e) a first handle extending substantially parallel to at least one of the sidewalls, and a second handle extending substantially along the cover portion such that the second handle extends at an angle to the first handle are used to control the dispensing of liquids from the container.

10. The method of claim 8, further comprises step (f) closing the opening with a cover cap and storing the pre-selected mixture and the another fluid within the container for dispensing at a later time.

11. The method of claim 8, wherein prior to step (e) the method includes the step of causing turbulence within the container to disperse the another fluid substantially throughout the liquid fuel.

12. The method of claim 11, wherein the causing turbulence is performed by shaking the container.

13. The method of claim 11, wherein the causing turbulence is performed by stirring the liquid fuel and the another fuel mixture with a tool that is inserted through the opening.
